(19) United States
(12) Patent Application Publication
(10) Pub. No.: US 2005/0011094 A1
(43) Pub. Date: Jan. 20, 2005

(54) Scrolling apparatus with one-way roller clutches

(76) Inventor: Reza Toraby-Payhan, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 10/887,253

(22) Filed: Jul. 8, 2004

Related U.S. Application Data
(62) Division of application No. 10/145,392, filed on May 14, 2002.
(60) Provisional application No. 60/290,727, filed on May 14, 2001.

(51) Int. Cl. G09F 11/18

(52) U.S. Cl. 40/471

(57) ABSTRACT

An outdoor sign system incorporating a scroll module adapted to display a message selected from a plurality of messages on a message web. A roller clutch is provided to permit a take-off side roller to move in one direction and a roller clutch is provided to permit a supply side roller to rotate in an opposite direction, thereby achieving a scroll system that avoids bunching of the scroll web while maintaining tautness of the web. A scroll module of the sign system includes a front face formed of a transparent material. A first roller and a second roller are mounted on opposite sides of the front face. A flexible message web is fed off of one roller and onto a second roller so that the message web displays a desired message through said front face. A motor or, alternatively, a hand crank, is used to impart rotation to one or both of the rollers. A gear mechanism, in association with an in-line roller clutch, acts on a shaft of a roller. In the single bi-directional motor embodiment the rollers are connected by a flexible and stretchable band, which allows for a differential tension build-up and slippage, as required. Since the supply side roller of the scroll system cannon push the opposing roller, the message web will remain taut.

### CROSS REFERENCE TO RELATED APPLICATION

This application claims the benefit of U.S. provisional application Ser. No. 60/290,727, filed on May 14, 2001, the disclosure of which is incorporated by reference.

### BACKGROUND OF THE INVENTION

1. Field of the Invention:

This invention relates to outdoor sign systems incorporating therein a scroll module adapted to display a message selected from a plurality of messages on a message web.

2. Background:

The use of message scrolls, wherein a message web is wound between two cylinders has been known since ancient times for the recording of various events and information. In more modern times the scroll system has been adapted for mechanical operations in order to display messages contained thereon. Though scrolling mechanisms for pictorial, graphical or numeral displays have existed for many years, due to the constant change in diameter of the opposing rollers (take off roller and supplier roller or vice versa) it has been a challenge to operate such scrolling mechanisms.

Prior to this invention, there have been essentially four different systems for coping with the challenge of operating such scrolling mechanisms. In the Netherland System (by TLI) and 3M System the problem is handled by two separate motors, one for each roller, which are controlled by complicated computer programs that manage the motors to turn in the same direction at different variable speeds. As an example, when take-off roller has less printed flexible film (resulting in a smaller diameter roller) than the supplier roller, the take-off roller motor must turn at a higher RPM than the motor on the supplier roller. The RPM relation has to constantly change to prevent film slackening or stressed tensioning and tearing. Any malfunction of one motor, electronic sensing or malfunction of RPM controlling electronics may result in either film tear or film bunching and a corresponding system breakdown. Such malfunctions are frequent, especially in outdoor settings that expose the motors and roller mechanism to extreme climate and temperature conditions and which affect the performance of the motors.

The Milwaukee System has two opposing driving motors that constantly run in opposite direction while the system is operating. The opposing rollers are engaged and disengaged with the motors via two electron mechanical clutches. In this System, the take-off roller is engaged and the supplier roller is disengaged. Such operation has constant tensioning and positioning problems due to take-off roller momentum build-up and coasting after disengagement, resulting in slack and non-tensioned flexible film. Moreover, the positioning of display frames are unpredictable, especially when the positioning sensor loses its reference mark due to coasting of the take-off roller.

The Skyline System is operated by one bidirectional motor and a spring-loaded tensioning ribbon. One end of the ribbon is connected to the take-off roller while the other end is connected to supplier roller, wrapped in the opposite direction of flexible film. This thin and narrow ribbon is located at one end of the rollers and runs through a spring-loaded pulley for tensioning purposes. Such a system is very cumbersome and hard to manufacture and install and even harder to repair in the field. The Abel System (Australia) and other similar systems operate with one bidirectional motor that runs a closed loop non-stretching belt that travels over three pulleys—one pulley directly connected to each shaft of the rollers and one spring-tensioned floating pulley. This type system is also hard to manufacture and install. Such systems are very bulky and hard to fit into confined spaces.

Many of the prior scroll assemblies are fairly complicated in structure and expensive to manufacture and maintain. Due to the complexity of the assemblies, especially where gear driven systems are provided, these units may experience a relatively high rate of breakdowns which decrease their usefulness, especially in locations that are difficult to access. A problem has been experienced by many of the prior art assemblies in that the message web tends to drift laterally of the view opening. Also the message web may lose its tension and sag. Further, due to the internal structure of these devices, the scrolling assemblies are difficult to illuminate interiorly so that illumination of the message band requires an external light source. This can diminish the practicality of the systems.

Accordingly, there is a need for a relatively low maintenance scrolling apparatus that is simple in construction yet reliable in operation. There is further need for such a scrolling apparatus module that may be internally illuminated and which may be used along or in combination with other modules to form a display sign that is particularly adapted to be used at locations having relatively difficult access.

It is thus an object of the present invention to provide a scrolling apparatus that may be constructed in module form and has a simple, useful drive assembly.

It is another object of the present invention to provide a scrolling apparatus in modular form that is simple in construction and reliable in operation and which may be internally illuminated so as to eliminate external light sources.

It is a still further object of the present invention to provide a scrolling apparatus for a message web that is wound on a pair of scrolling rollers such that a selected message is guided to a desired location and maintained in a taut, neat manner.

### SUMMARY OF THE INVENTION

These and other objects are achieved by the scroll apparatus and drive assembly according to the presently preferred embodiment of this invention, which is comprised of a system based on the use of in-line one-way roller clutches inserted in the driving gear and slipped over each of the roller shafts. The in-line roller clutches engage the take-off side shaft in one direction and the roller clutch of the supply side in the opposite direction.

The system of the present invention can be operated in two different ways. In a two-motor system, the motors are connected to the driving electronics or manual electrical switched system as if they were one-motor. The two bidirectional motors when energized, turn in the same direction. The supply side motor is selected to run at a slightly higher RPM due to the fact that it is free wheeling, thus enabling the take-off side motor to run without the down gear resistance of the opposing drive motor and gears. The supply side mechanism can never push the opposing film roller and can only pull the film roller, eliminating bunching and unnecessary stress. In a single motor arrangement, this system operates by a directional motor that engages one of the roller mechanisms via an in-line roller clutch and that has a pulley shoulder on the gear and an identical diameter pulley on the opposite roller system. The two pulleys are connected by a flexible and stretchable band such as a silicone rubber belt that grips and slips as needed. The belt allows for a differential tension build-up on the opposing sides of the pulley due to the fact that a freewheeling side mimics any belt tension build-ups, and by slipping the belt releases tension as it is needed. Since the supply side mechanism cannot push the film roller, the film will never bunch up and the system will be very reliable. This system can also be operated by a non-motorized hand-cranking system, replacing the motor by a crank (flexible or rigid) mechanism that can be operated by external means.

A better understanding of the present invention, its several aspects, and its advantages will become apparent to those skilled in the art from the following detailed description, taken in conjunction with the attached drawings, wherein there is shown and described the preferred embodiment of the invention, simply by way of illustration of the best mode contemplated for carrying out the invention.

### BRIEF DESCRIPTION OF THE DRAWINGS

FIG. 1 is a perspective view of a display sign incorporating modules according to the presently preferred embodiment of the invention.

FIG. 2 is a perspective view of a scroll module according to the preferred embodiment of the present invention.

FIG. 3 is a view of the scroll module having a fluid pocket system in association therewith.

### DETAILED DESCRIPTION OF THE INVENTION

Before explaining the present invention in detail, it is important to understand that the invention is not limited in its application to the details of the embodiments and steps described herein. The invention is capable of other embodiments and of being practiced or carried out in a variety of ways. It is to be understood that the phraseology and terminology employed herein is for the purpose of description and not of limitation.

The present invention is directed to an improved display apparatus, preferably in the form of an outdoor sign, that has a changeable message. The present invention is particularly adaptable to display messages that need to be changed from time to time. For example, the display apparatus described herein is useful to display prices, such as gasoline prices. The present invention is constructed to be an internally lit display incorporating one or more scroll modules having a novel and useful drive system so that the message surface is maintained in an aligned, taut matter.

The present invention is based upon my discovery that through the utilization of a pair of in-line one-way roller clutches inserted in the driving gears so as to permit the take off side shaft to move in one direction and the roller clutch of the supply side to move in an opposite direction, there is achieved an improved scroll system which avoids bunching of the scroll web while maintaining the web in a taut, neat manner.

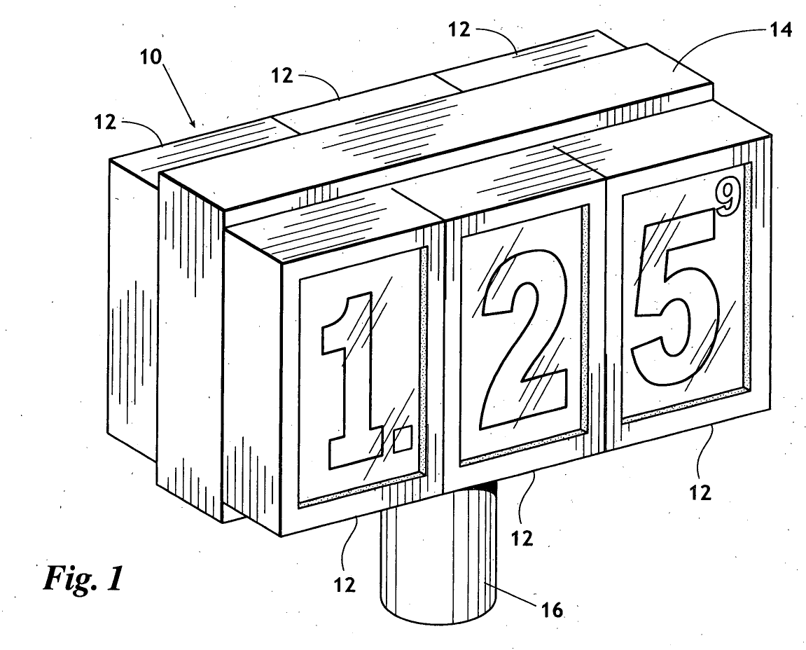

The preferred embodiment of the present invention is incorporated in the display sign 10 of FIG. 1 wherein a plurality of scroll modules 12 having the in-line clutch arrangement in association with the scrolls therein are mounted in a central housing 14 that is supported on, for example, a pole 16. It should be appreciated that sign display 10 incorporates a plurality of modules 12. However, the general form of the preferred embodiment of the present invention comprises each module 12 since these modules stand as individual message display units.

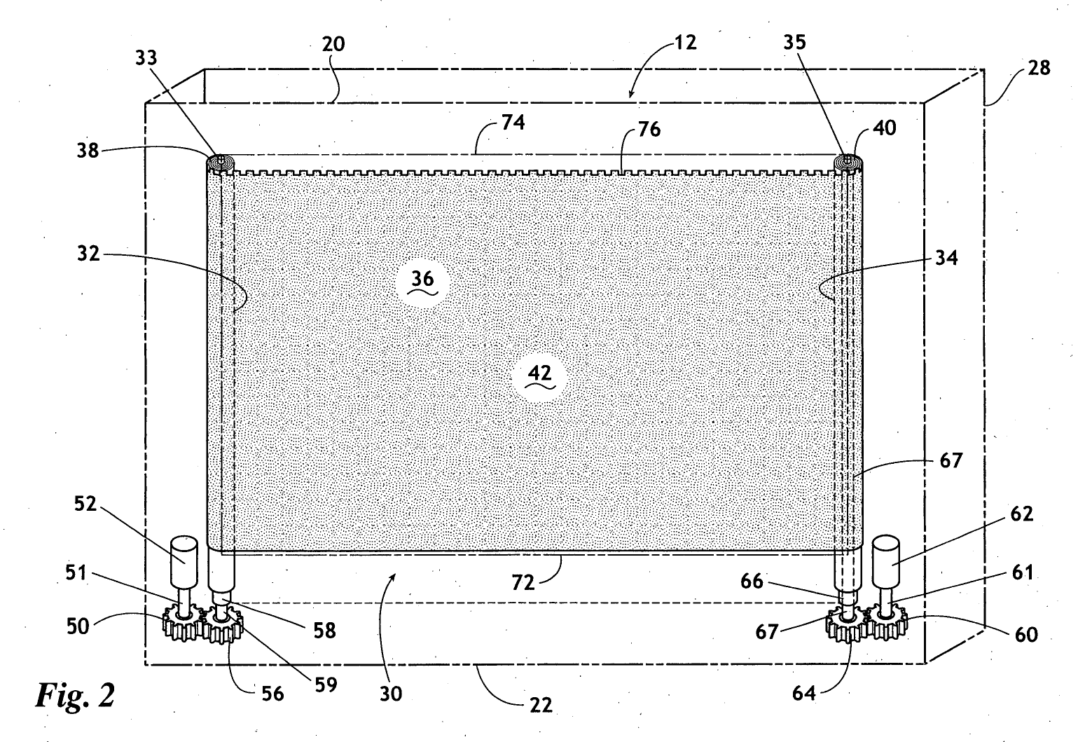

A module 12 according to the preferred embodiment of the present invention is best shown in FIG. 2. The module 12 includes a framework formed out of sheet metal having a top wall 20, bottom wall 22, side wall 24 and side wall 26. Module 12 has a back 28 and a front face 30 formed of a transparent material to define a viewing area for a selected message. Module 12 thus has a boxlike construction and supports a pair of scrolling rollers 32 and 34 therein.

Rollers 32 and 34 are totally journaled in the framework on spaced-apart parallel axes, so defined by pairs of trunnion pins 33 and 35 and receive a flexible message web 36 that carries the desired message, such as letters, numbers or other messages for viewing through front face 30. Preferably web 36 is constructed of a flexible, plastic material that forms an opaque background for a translucent message, such as the numeral 1 as shown in FIG. 1. Message web 36 has its opposite end edges attached to rollers 32 and 34, respectively, with its end portions 38 and 40 being wrapped around rollers 32 and 34, respectively so that web 36 may be advanced from one roller to the other. An exposed portion of web 36 extends between rollers 32 and 34 along front face 30 with the exposed portion thus carrying a selectively changeable message for display through the front face 30. Message web 36 is reversibly advanced by rotation of the rollers 32 and 34 since the web is wound from one roller to the other. To this end, roller 32 is rotated by a drive mechanism comprised of a drive wheel 50 which is connected to the drive shaft 51 of motor 52 whereby the drive wheel 50 engages with the gear mechanism 56 which is in association with the in-line one way roller clutch 58 which is positioned on the shaft 59 of roller 32. In a similar manner roller 34 is rotated by a drive mechanism comprised of a drive wheel 60 which is connected to the drive shaft 61 of motor 62 whereby the drive wheel 60 engages with the gear mechanism 64 which is in association with the in-line one way roller clutch 66 which is positioned on the shaft 67 of roller 34. Motors 52 and 62 are rigidly secured to the framework and the drive wheels of each directly connect with the gear means which are in association with the in-line one way roller clutch 58 and 66. In operation the in-line clutch is so positioned that the take off side of roller 32 is in one direction and the roller clutch of the supply side, roller 34, is so adapted as to engage in the opposition direction.

Message web 36 is mounted between a lower guide 72 and an upper guide 74 to align web 36 so that is does not move laterally of its path of movement from movement between rollers 32 and 34. Message web can be indexed along its upper edge such as by index openings 76 which pass index reading elements which automatically monitors web 36 in order to automatically control the message displayed through the front face 30.

As noted above, a plurality of modules 12 may be mounted to form a sign display 10, with sign display 10 being best shown in FIG. 1. The backs 28 of the modules 12 are mounted over corresponding openings of housing 14 so that light may radiate outwardly and pass through each of the transparent pressure plates to illuminate each message web 36 for viewing through front face 30. Housing 14 can be an enclosed structure into which modules 12 are inserted. In such case the housing 14 would have a transparent window covering over each view window adjacent the front of the module in the structure, thus eliminating the need for a separate transparent face 30 on each of the modules 12.

In a presently preferred embodiment of the present invention the module assembly having been adapted with the in-line one way clutch systems as disclosed supra can be utilized in an aqueous pocket assembly as disclosed in U.S. Pat. No. 5,125,176, the entire disclosure of which is incorporated by reference. In the practice of this aspect of the invention, a pocket is provided which is comprised of an outer pane 30 and an inner pane 28. The edges of panes forming a pocket are sealed so as to form a liquid-tight pocket. In some applications of the invention the pocket is filled with a fluid such as ethylene glycol and water which is transparent so that the film or the inner panes are readily visible and free of distortion when viewed from the exterior. When utilizing the liquid system in the construct of the module, a reservoir tank in fluid communication with the pocket can be provided in the event the pocket requires refilling. Preferably, the tank is so positioned as to permit gravity flow to draw fluid in the tank into the pocket. The various modules may be so interconnected that a single reservoir tank acts as a supply for all pockets. In the event that a space exits between the background face and the outer panes, fluid may also be place therebetween.

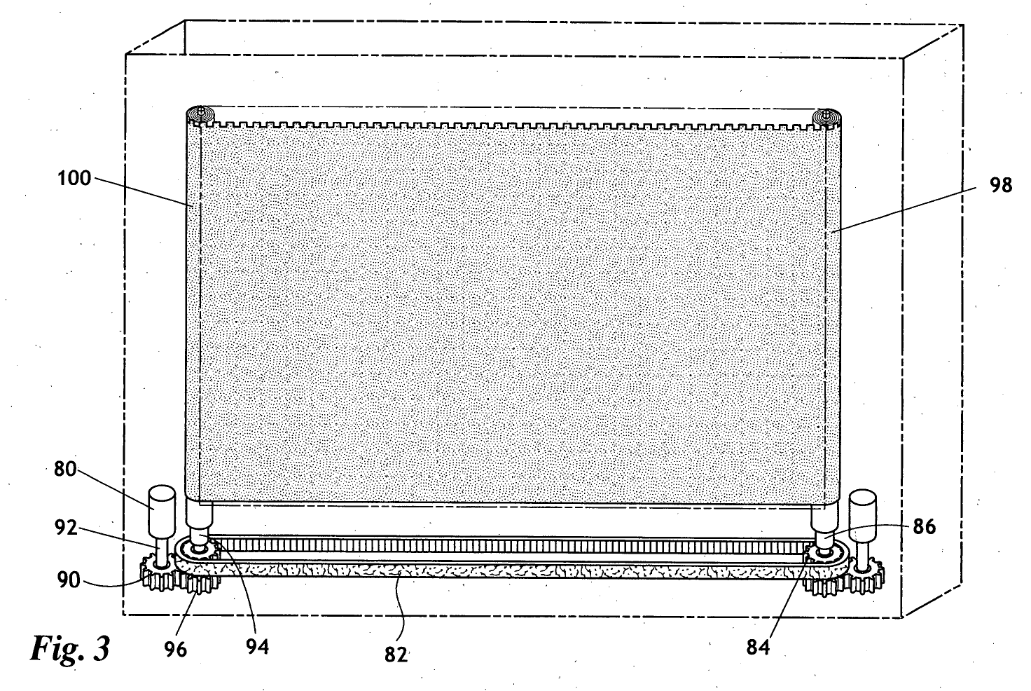

FIG. 3 shows an alternative drive system wherein a single motor 80 is employed which is so adapted through the placement of belt 82 on gear means 84 having an in-line one-way clutch 86 with the direction of an in-line clutch 94 engaged by drive mechanism 90 mounted on the shaft 92 of motor 80 being adapted such that the engagement of the clutches are opposite, operation of the desired display can be achieved with a single motor system.

In the operation of the system of the present invention with a single motor, such a system operates by a bidirectional motor 80 that engages the roller mechanisms via in-line roller clutch 94 that has a pulley 96 with a shoulder on the gear 90 and an identical diameter pulley 84 on the opposite roller system. The two pulleys 84 and 96 are connected by a flexible and stretchable band 82 such as a silicone rubber belt that grips and slips as needed. The band allows for a differential tension build-up on the opposing sides of the pulley due to the fact that a freewheeling side mimics any belt tension build-ups, and by slipping the belt releases tension as needed. Since the supply side system of the scroll 98 cannot push the film roller 100, the film will never bunch up and the system will be very reliable.

If desired, the motors 52, 62 and/or 80 can be eliminated and the system operated through the use of a crank mechanism which can be inserted in the module so as to actuate manually the drive mechanism of either the single or two motor systems.

In a presently preferred embodiment there is employed a dual motor system which has been adapted as to have it placed in association with supply and take-off rollers wherein the in-line roller clutches are so placed that when one of such in-line roller clutches is engaged, the other in-line clutch is freewheeling.

Suitable in-line roller clutches, which are also known as overrun clutches or DC roller clutches, for use in construction of the modules of the present invention are commercially available and as such the construct of same do not per se form a part of this invention. One presently available source for such in-line roller clutches is Torrington Company in Torrington, Conn.

While the invention has been described with a certain degree of particularity, it is understood that the invention is not limited to the embodiment(s) set for herein for purposes of exemplification, but is to be limited only by the scope of any allowed claim or claims, including the full range of equivalency to which each element thereof is entitled.

1. A scroll module for a scrolling apparatus comprising:
a front face formed of a transparent material;
a first roller and a second roller mounted on opposite sides of said front face;
a flexible message web having a first end portion wrapped around said first roller and having a second end portion wrapped around said second roller, said message web for displaying a desired message through said front face;
a driver for imparting rotation to one of said first roller and said second roller;
a first one way roller clutch positioned on said first roller, said first roller clutch for transferring rotational energy from said driver to said first roller in a first rotational direction and for free spinning in a second rotational direction; and
a second one way roller clutch positioned on a second roller, said second one way roller clutch for transferring rotational energy from said driver to said second roller in a first rotational direction and for free spinning in a second rotational direction, whereby when said first roller is driven, said second roller free spins.

2. The scroll module according to claim 1, further comprising:
an index reading element proximate said front face; and
wherein said message web has a plurality of index openings along an edge thereof, said index openings for passing said index reading element to permit said index reading element to automatically monitor and said message web for assisting in accurately locating a desired message in said front face so that said message is viewable.

3. The scroll module according to claim 1 wherein:
said driver is a motor operatively connected to one of said first roller and said second roller, said motor for driving one of said first roller and said second roller.

4. The scroll module according to claim 3 wherein:
said motor is a bi-directional motor.

5. The scroll module according to claim 3 further comprising:
a second motor operatively connected to one of said first roller and said second roller such that a motor is provided to each of said first roller and said second roller; and
wherein said motor is a supply side motor and said second motor is a take-off motor, said supply side motor selected to run at a slightly higher RPM than said take-off motor.

6. The scroll module according to claim 1 further comprising:
a gear mechanism operatively communicating with said one way roller clutch and with said driver for transmitting movement from said driver to one of said first roller and said second roller.

7. The scroll module according to claim 1 further comprising:
a guide located proximate a perimeter of said front face for aligning said message web.

8. The scroll module according to claim 1 wherein:
the scroll module is a part of a plurality of modules that are mounted to form a sign display.

9. The scroll module according to claim 1 wherein:
the scroll module is mounted proximate a housing;
a back of said scroll module has an opening that is mounted over a corresponding opening of said housing so that light may radiate outwardly and pass through said transparent material of said front face to illuminate said message web for viewing through said front face.

10. The scroll module according to claim 1 wherein:
said transparent material of said front face comprises an outer pane and an inner pane; and
wherein said message web is in a space between said outer pane and said inner pane.

11. The scroll module according to claim 10 wherein:
said space between said outer pane and said inner pane is filled with a fluid.

12. The scroll module according to claim 1 further comprising:
a flexible and stretchable band communicating said first roller and said second roller.
